(19) United States
(12) Patent Application Publication
(10) Pub. No.: US 2025/0362415 A1
(43) Pub. Date: Nov. 27, 2025

(54) Hyperbolic Positioning Methods and System

(71) Applicants: Charles F. Barry, Santa Clara, CA (US); Marc A Weiss, Aptos, CA (US); Robert A Swirsky, Sunnyvale, CA (US); John E. Hopwood, Albany, CA (US); James E Garbagnati, Union City, CA (US)

(72) Inventors: Charles F. Barry, Santa Clara, CA (US); Marc A Weiss, Aptos, CA (US); Robert A Swirsky, Sunnyvale, CA (US); John E. Hopwood, Albany, CA (US); James E Garbagnati, Union City, CA (US)

(21) Appl. No.: 18/049,515

(22) Filed: Oct. 25, 2022

Related U.S. Application Data
(60) Provisional application No. 63/271,986, filed on Oct. 26, 2021.

(51) Int. Cl. G01S 19/39; G01S 19/46

(52) U.S. Cl. CPC G01S 19/393; G01S 19/46

(57) ABSTRACT

A method of determining the location of client system, including: determining the round trip times of bidirectional communications between the client system and first, second, and third reference systems, wherein the locations of the first, second, and third reference systems are known at the time of reception from the client system and at the time of transmission to the client system; calculating a first location of the client system using spherical lateration based upon the determined round trip times; determining the time difference of arrival of the bidirectional communications between client system and the first, second, and third reference systems with respect to a fourth reference system wherein the location of the fourth reference system is known at the time of reception from the client system and at the time of transmission to the client system; calculating a second location of the client system using time difference of arrival hyperbolic positioning based upon the determined time difference of arrival between the client and the first, second, third systems with respect to the fourth reference system; and determining the position of the client system by combining the first location and the second location.

### CROSS-REFERENCE TO RELATED APPLICATION

This application claims the benefit of U.S. Provisional Patent Application No. 63/271,986, filed Oct. 26, 2022, which is incorporated, for all purposes, by reference herein in its entirety.

### STATEMENT OF GOVERNMENT SUPPORT

This invention was made with Government support under contract FA8649-22-9-9022 awarded by the United States Air Force (USAF) AFWERX. The Government has certain rights in the invention.

### TECHNICAL FIELD

Various exemplary embodiments disclosed herein relate generally to a hyperbolic positioning methods and system.

### BACKGROUND

Since inception in 1970's, the Global Positioning System (GPS) has become inexpensive and ubiquitous. GPS capability now found in nearly all mobile, laptops, autos, and IoT devices. In addition to GPS there are number of other global navigation satellite systems (GNSS) including: Galileo (EU); GLONASS (Russia); BeiDou (China); QZSS (Japan), IRNSS (India), etc. GNSS systems may be further augmented by Wide-Area-Augmentation System (WAAS) or Assisted-GPS (A-GPS). GNSS provide accurate global location. For example, GPS accuracy is typically <10 m for consumers, <1 m for precision navigation, and 1 cm for survey.

GNSS have a number of vulnerabilities. These may include: obstructions such as geography, foliage, urban canyons, etc.; signal issues such as multi-path, atmospheric conditions, interference, noise, space weather, jamming, spoofing, etc.; lack of coverage such as indoors, underground, undersea, in polar regions above 75° latitude, etc.; and destruction of satellite capabilities due to space debris, attack, etc.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method of determining the location of client system, including: determining the round trip times of bidirectional communications between the client system and first, second, and third reference systems, wherein the locations of the first, second, and third reference systems are known at the time of reception from the client system and at the time of transmission to the client system; calculating a first location of the client system using spherical lateration based upon the determined round trip times; determining the time difference of arrival of the bidirectional communications between client system and the first, second, and third reference systems with respect to a fourth reference system wherein the location of the fourth reference system is known at the time of reception from the client system and at the time of transmission to the client system; calculating a second location of the client system using time difference of arrival hyperbolic positioning based upon the determined time difference of arrival between the client and the first, second, third systems with respect to the fourth reference system; and determining the position of the client system by combining the first location and the second location.

Various embodiments are described, wherein determining the position of the client system by combining the first location and the second location includes using a Kalman filter.

Various embodiments are described, wherein the communication from one of the first, second, or third reference system is a signal of opportunity.

Various embodiments are described, wherein the signal of opportunity is one of a radio signal, a television signal, a mobile communication signal, a Wi-Fi signal, a satellite signal, a LORAN signal, a ham radio signal, an aid to navigation signal (VOR, ADS-B), a time reference signal, a LORAN signal, eLORAN signal, and a free space optical signal.

Various embodiments are described, wherein determining the round trip times of the bidirectional communication is based upon position and navigation information on of the client system, first reference system, second reference system, and third reference system.

Various embodiments are described, wherein one of the client system, first reference system, second reference system, and third reference system is moving.

Various embodiments are described, wherein calculating a first location of the client system using spherical lateration, calculating a second location of the client system using time difference of arrival hyperbolic positioning, and determining the position of the client system by combining the first location and the second location are carried out by a networked processor.

Various embodiments are described, wherein calculating a first location of the client system using spherical lateration, calculating a second location of the client system using time difference of arrival hyperbolic positioning, and determining the position of the client system by combining the first location and the second location are carried out by one of the first, second, third, or fourth reference systems.

Various embodiments are described, wherein calculating a first location of the client system using spherical lateration, calculating a second location of the client system using time difference of arrival hyperbolic positioning, and determining the position of the client system by combining the first location and the second location are carried out by the client system.

Further various embodiments relate to a method of determining the location of client system, including: determining the time of arrival at a reference system of first, second, and third signals of opportunity (SOOP) from first, second, and third SOOP systems wherein the locations of the reference system and the first, second, third SOOP systems are known at the time of reception of the first, second, and third SOOP; determining the time of arrival at the client system of the first, second, and third signals of opportunity (SOOP) from the first, second, and third SOOP systems; determining the time difference of arrival of the first, second, and third SOOP at the reference system and client system; and calculating a location of the client system using time difference of arrival hyperbolic positioning based upon the determined time difference of arrivals of the first, second, and third SOOP at the client system and the reference system.

Various embodiments are described, wherein the position of the client system is filtered using a Kalman filter.

Various embodiments are described, wherein the signal of opportunity is one of a radio signal, a television signal, a mobile communication signal, a Wi-Fi signal, a satellite signal, a LORAN signal, a ham radio signal, an aid to navigation signal (VOR, ADS-B), a time reference signal, a LORAN signal, eLORAN signal, and a free space optical signal.

Various embodiments are described, wherein one of the client system, SOOP system, and reference system is moving.

Various embodiments are described, wherein calculating a location of the client system using time difference of arrival hyperbolic positioning is carried out by a networked processor.

Various embodiments are described, wherein calculating the location of the client system using time difference of arrival hyperbolic positioning are carried out by the reference system.

Various embodiments are described, wherein calculating the location of the client system using time difference of arrival hyperbolic positioning is carried out by the client system based upon time of arrival information received from a networked processor.

Further various embodiments relate to a method of determining the location of client system, including: receiving, by the client system from an external system, location and navigation information regarding a plurality of satellites, wherein the external system determines the location of the plurality of satellites using time difference of arrival hyperbolic positioning based upon time difference of arrival of transmissions received from the plurality of satellites; determining the time difference of arrival of communications received by the client system from four of the plurality of satellites; and calculating a location of the client system using time difference of arrival hyperbolic positioning based upon the determined time difference of arrival between the client and the four satellites.

Various embodiments are described, wherein the external system determines the position of the plurality of satellites by filtering location data of the plurality of satellites using a Kalman filter.

Various embodiments are described, wherein the external system includes a plurality of reference systems receiving transmissions from the plurality of satellites.

Various embodiments are described, wherein the external system includes a processor configured to determines the location of the plurality of satellites using time difference of arrival hyperbolic positioning based upon time difference of arrival communication received from the plurality of satellites.

Various embodiments are described, wherein one of the plurality of reference systems is moving.

Various embodiments are described, wherein the client system is moving.

Various embodiments are described, wherein one of the client system, first reference system, second reference system, and third reference system is moving.

### BRIEF DESCRIPTION OF THE DRAWINGS

In order to better understand various exemplary embodiments, reference is made to the accompanying drawings, wherein embodiments of a device for use in computer-aided surgery are shown:

FIG. 1 illustrates a plurality of client systems in an area where GNSS is not available or denied along with a plurality of reference systems;

FIG. 2A illustrates the RTT using the network timing protocol (NTP);

FIGS. 2B, 2C, and 2D introduce a new position, navigation, and timing protocol (PNTP);

FIG. 3 illustrates a first embodiment of the operation of a PNT system that may be used for client system location and navigation when GNSS systems are not available to the client system;

FIG. 4 illustrates a second embodiment of the operation of a PNT system using SOOP that may be used for client system location and navigation when GNSS systems are not available to the client system;

FIG. 5 illustrates a third embodiment of the operation of a PNT system using satellite signals that may be used for client system location and navigation when GNSS systems are not available to the client system;

FIG. 6 illustrates a fourth embodiment of the operation of a PNT system using a combination of reference system signals, SOOP, and satellite signals for client system location and navigation when GNSS systems are not available to the client system; and

FIG. 7 illustrates an exemplary hardware diagram for implementing PNT system.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Global navigation satellite systems (GNSS) may use spherical lateration to determine the location of a GNSS receiver. Each satellite in the GNSS system transmits a signal at a precise time. That signal may include the time of transmission and the location of the satellite when the transmission is made. In other embodiments, the location of the satellite may be determined based upon known navigation information regarding the satellite and the time of transmission. The GNSS receiver notes the time it receives a signal from a GNSS satellite. Based upon the receive time and the transmit time, the GNSS receiver may determine a range to the transmitting satellite. This range value defines a sphere around the known location of the transmitting GNSS satellite. When the GNSS receiver receives signals from three GNSS satellites, three spheres are defined, and the intersection of those three spheres defines the location of the GNSS receiver. The accuracy of this location will be affected by at least the accuracy of the timing and the accuracy of location of the transmitting satellite. Further, signal noise and interference may also contribute to the accuracy of the calculated location of the GNSS receiver.

GNSS have various vulnerabilities including the following: satellite position and time errors; doppler shifts due to satellite and/or receiver motion; ionospheric scintillation; tropospheric scintillation; signal masking; signal jamming; signal spoofing; multipath interference; and antenna and receiver effects. For example, malicious jamming may be used to prevent a GNSS receiver from being able to determine its location. Malicious spoofing may cause a GNSS receiver to determine a false location. As a result, there may be important situations where a GNSS receiver is denied the ability to determine its true location. One example of where this may occur is during military operations where an adversary jams or spoofs GNSS signals.

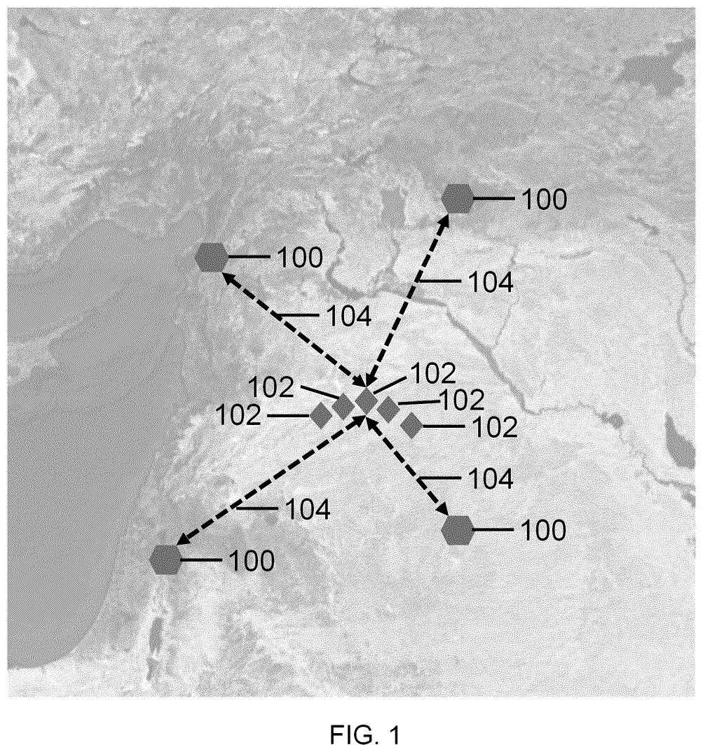

While various mitigation techniques may be used to overcome GNSS vulnerabilities, there may still be situations where GNSS is not available or denied. As a result, there remains a need for an alternative position, navigation, and timing (A-PNT) system for use in situations where GNSS is not available or denied. FIG. 1 illustrates a plurality of client systems 102 in an area where GNSS is not available or denied along with a plurality of reference systems 100. The client system 102 may be any type of system that may be stationary or moving. The reference systems 100 are at known locations. The location of the reference systems 100 may be known by a variety of means. If the reference system 100 is stationary, then its precise location may be known by surveying or the use of a GNSS receiver. If the reference system 100 is mobile, then its location may be known by GNSS or some sort of other precision locating system such as inertial management units, barometers/altimeters, other satellite systems, radio frequency (RF) sensors that detect angle of arrival or doppler, beacons, etc. Such reference systems 100 may include dedicated systems that assist in helping to provide PNT to the client system 102 or they may be systems that provide signals of opportunity (SOOP). The current position and navigation parameters for the reference system 100 may be maintained by collecting location information and filtering it such as by using a Kalman filter. Further, data from a plurality of sources may be collected and fused together using for example a Kalman filter, a particle filter, machine learning/neural network model, etc.

The reference systems 100 may have an RF link 104 with the various client systems 102. The RF link 104 may be, for example, an ultra-wideband (UWB) link. The reference system 100 may send a unidirectional communication over the RF link 104 that the client system 102 may use to determine its location. Time difference of arrival of signals from different reference systems 100 may be used along with hyperbolic positioning to determine the location of the client system 102. In order to use hyperbolic positioning, the locations of the reference systems 100 must be known. This location information may come in the communication information from the reference system 100. Alternatively, if the location of the reference system 100 is fixed, then an identifier of the specific reference system 100 may be included in the communication information. Then the client system 102 may look up the location of the reference system 100 associated with the identifier. In yet another alternative, the location of the reference system 100 may be communicated by an external system, for example from a cloud-based service. When reference system transmissions are synchronized to occur at the same time, or with known offsets among the set of references, the client can perform hyperbolic positioning using time difference of arrival without the need to know the specific time of transmission. If reference systems transmit asynchronously with respect to each other, then the times of transmissions from the references may be included in the communication information or may be communicated by an external system, for example from a cloud-based service. The client can perform hyperbolic positioning using the time difference of arrival compensated by the differences in the transmission times.

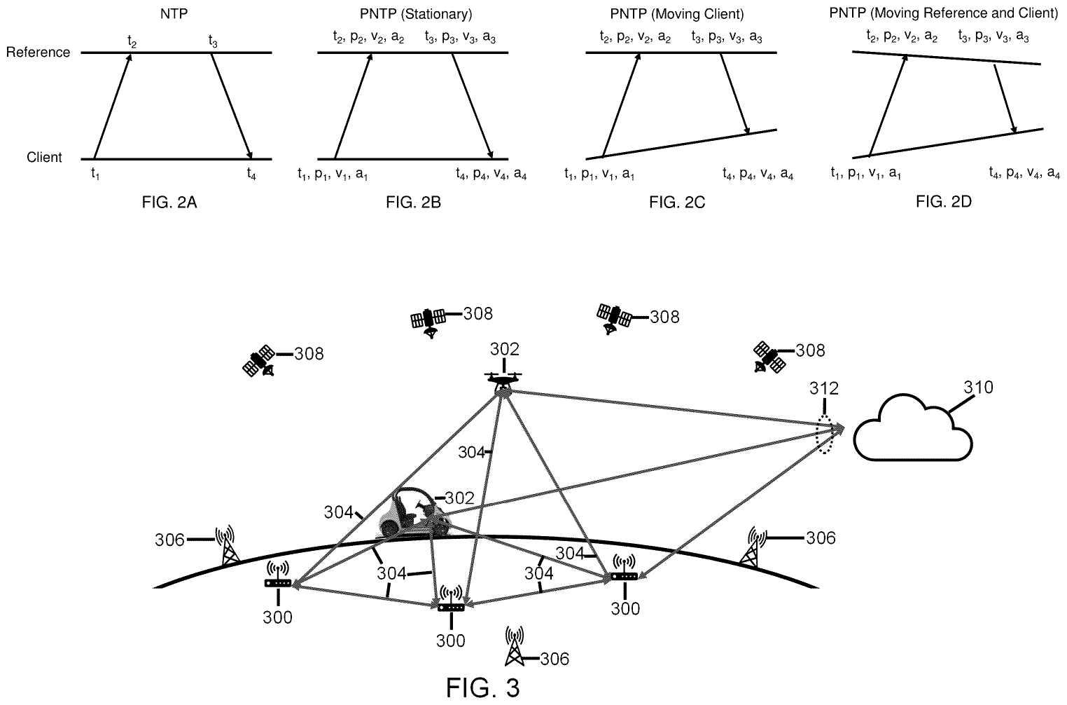

The reference system 100 may engage in a bidirectional communication over the RF link 104 that the client system 102 may use to determine its location. This bidirectional communication allows for the use of spherical lateration to determine the location of the client system 102. The round-trip time (RTT) of the bidirectional communication may be used to determine the distance of the client system 102 from the reference systems 100 that then may be used to determine the location of the client system 102 using spherical lateration. FIG. 2A illustrates the RTT using the network timing protocol (NTP). In FIG. 2A the RTT may be calculated as t₄−t₁−(t₃−t₂). The distance, or range, from the client to the reference is then RTT*c/2, where c is the speed of light in air, space, or vacuum as the case may be. FIGS. 2B, 2C, and 2D introduce a new position, navigation, and timing protocol (PNTP). In the new PNTP protocol, position, velocity, and acceleration (pₓ, vₓ, and aₓ) are also communicated along with the time. The additional navigation parameters will allow for the distance between to the reference system 100 and the client system 102 to be more accurately determined when one or both of the reference system 100 and the client system 102 are moving. In FIG. 2B, neither the reference system 100 nor the client system 102 are moving, so the navigation parameters will not affect the RTT calculation. In FIG. 2C the client system 102 is moving as shown by the slanted lower line. In FIG. 2D both the reference and the client are moving. In these cases, the calculation of the range will be compensated based upon the navigation parameters. As a result, the communication between the reference system 100 and the client system 102 may use the PNTP in order to determine the range between the reference system 100 and the client system 102 more accurately. The figures depict motion in one-dimension for ease of illustration, but motion in three dimensions is handled. The PNTP protocol may be extensible to exchange additional parameters, including 6 degree of freedom rotation, angular velocities and accelerations that may be measured by inertial management units, in addition to parameters measured from additional sensors such as barometers, magnetometers, etc.

FIG. 3 illustrates a first embodiment of the operation of a PNT system that may be used for client system 302 location and navigation when GNSS systems are not available to the client system 302. The PNT system may include a plurality of reference systems 300 and client systems 302. In this example, two client systems 302 are illustrated: a vehicle and a drone. The PNT system may also include an external system 310. The external system 310 may be for example a cloud-based system that stores and processes PNT information. The external system 310 may also send PNT information including the client system 302 location to the client system 302 or other systems as needed. The external system 310 may communicate with the client systems 302 and reference systems 300 via external links 312. The external links 312 may be, for example, either wired, optical or wireless links depending upon the specific application.

The reference systems 300 may be in a fixed location or may be mobile. In either situation the reference systems 300 have a known position. This position may be known in the case of a fixed reference system 300 using surveying, GNSS positioning if available, LORAN/e-LORAN, celestial positioning, other time reference signals, ham radio signal, free space optical signal, etc. If the reference system 300 is mobile, then its location may be known based upon GNSS positioning or some other positioning technology. This allows for the reference systems 300 to be used to help client system 302 determine their location when GNSS positioning is not possible.

The reference system 300 communicates with the client system 302 using a RF link 304. Either a unidirectional link or bidirectional link may be used. If the link is unidirectional, then the client system 302 and a first reference system 300 receives signals from the three other reference systems 300. TDOA of the three different received signals with respect to the first reference systems along with the known position of the four reference systems 300 may then be used to determine the location of the client system 302 using hyperbolic lateration. This process is then repeated over time and the client system 302 location is updated based upon the updated information. The various measurements of the client system 302 location may be filtered, for example, by using a Kalman filter. The Kalman filter helps to maintain the PNT for the client system 302. When reference system transmissions are synchronized to occur at the same time, or with known offsets among the set of references, it is not necessary for the client to know the specific time of transmission to perform hyperbolic positioning. If reference systems transmit asynchronously to each other, then the times of transmissions from the references may be included in the communication information or may be communicated by an external system, for example from a cloud-based service.

This processing may be done at the client system 302. In other embodiments the first or any other reference system 300 may be used to determine the position of the client system 302. In yet other embodiments, the external system 310 may be used to determine the position of the client system 302. In this situation, the external system 310 communicates with the client system 302 and the first reference system 300 via external links 312 to receive the TDOA information for the reference system 300 signals received by the client system 302 and the first reference system 300. Then the external system 310 provides position or PNT information back to the client system 302 using external link 312. The external system 310 may be used when such a link is available. Further, even when the processing is done on the client system 302, the same processing may also be done on the external system 310 so that it provides a backup to the client system 302.

If the link is bidirectional, then the client system 302 receives signals from three reference systems 300. The RTT of the three different bidirectional transmissions may be used to determine the range between the client system 302 and the three reference systems 300. These three range values along with the known position of the reference systems 300 may then be used to determine the location of the client system 302 using spherical lateration. This may be repeated, and the client system 302 location is updated over time. The various measurements of the client system 302 location may be filtered, for example, by using a Kalman filter. The Kalman filter helps to maintain the PNT for the client system 302.

In addition, if a fourth reference system 300 is available, then TDOA may be computed and hyperbolic lateration may also be used to determine the location of the client system 302 as described above. Both spherical lateration and hyperbolic lateration position measurements may be combined using filtering such as the Kalman filter or other filtering methods discussed above. The use of these two different measurements will provide greater location accuracy than the use of only one of them.

Again, the processing for the spherical lateration, hyperbolic lateration, and the filtering may be done either at the client system 302, the first or any other reference system 302, or the external system 310.

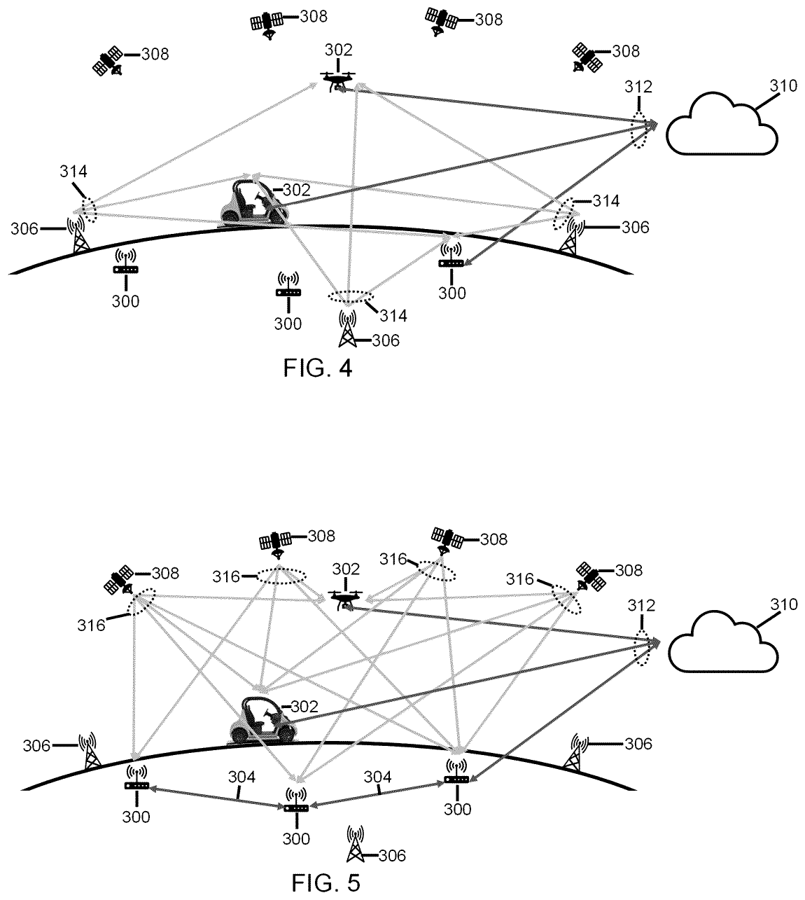

FIG. 4 illustrates a second embodiment of the operation of a PNT system using SOOP 314 that may be used for client system location and navigation when GNSS systems are not available to the client system. The PNT system may take advantage of SOOP 314 transmitted by the SOOP systems 306. The SOOP systems 306 may be television transmitters, cell towers, radar systems, Wi-Fi, etc. Typically, the location of SOOP systems 306 is known as they are stationary systems. Because of this, their signals may be used to assist in determining the location of the client system 302 using TDOA and hyperbolic lateration. Both the client system 302 and the reference system 300 will receive and timestamp the SOOP 314 from the SOOP system 306. The TDOA of this signal is determined. Then the TDOA is determined for two further SOOP 314 from two additional different SOOP systems 306. Then because the locations of the SOOP systems 306 are known, the TDOAs may be used to determine the location of the client system 302. As previously discussed, the location processing may be carried out at the client system 302, the reference system 300, or the external system 310. As before, the external system 310 may compute the location of the client system 302 as a backup to either the client system 302 or reference system 300. Further, filtering such as Kalman filtering may be used to track the location and navigation parameters of the client system 302.

In another variation, if the locations of the SOOP system 306 are not known, if four reference systems 300 are available, the locations of the SOOP system 306 may each be determined by the reference systems 300 using TDOA and hyperbolic lateration.

FIG. 5 illustrates a third embodiment of the operation of a PNT system using satellite signals that may be used for client system location and navigation when GNSS systems are not available to the client system. The PNT system may take advantage of satellite signal 316 emitted from satellite 308. The satellite signal 316 is a SOOP that might be used by the client system 302 to determine its location. The satellites 308 may be any satellite system that emits signals that may be received by the client system 302. As the location of the satellites 308 are initially not known, their location needs to be determined. Four reference systems 300 may be used to determine the location of each of the satellites 308. The reference systems 300 may use TDOA of the satellite signals 316 along with hyperbolic lateration to determine the location of the satellites 308. As the location of the satellite 308 is updated, these position measurements may be filtered using for example a Kalman filter to determine the location and navigation parameters, i.e., the ephemeris, of each of the satellites 308.

With this position and navigation information of the satellites 308, the satellite signals 316 may be used by client system 302 to determine the client system 302 location. This will be done using TDOA and hyperbolic lateration using the location information about the satellites.

As before, the calculations to determine the position and track of the satellites 308 may be carried out at the client system 302, the reference system 300, or the external system 310, or any combination of these systems. Further, the calculations to determine the position of the client system 302 may be carried out at the client system 302, reference system 300, the external system 310, or any combination thereof. Also, the external system 310 may also track the location of the client system 302 as a backup to either the client system 302 or the reference system 300. As described above, filtering such as Kalman filtering may be used to track the location and navigation parameters of the client system 302.

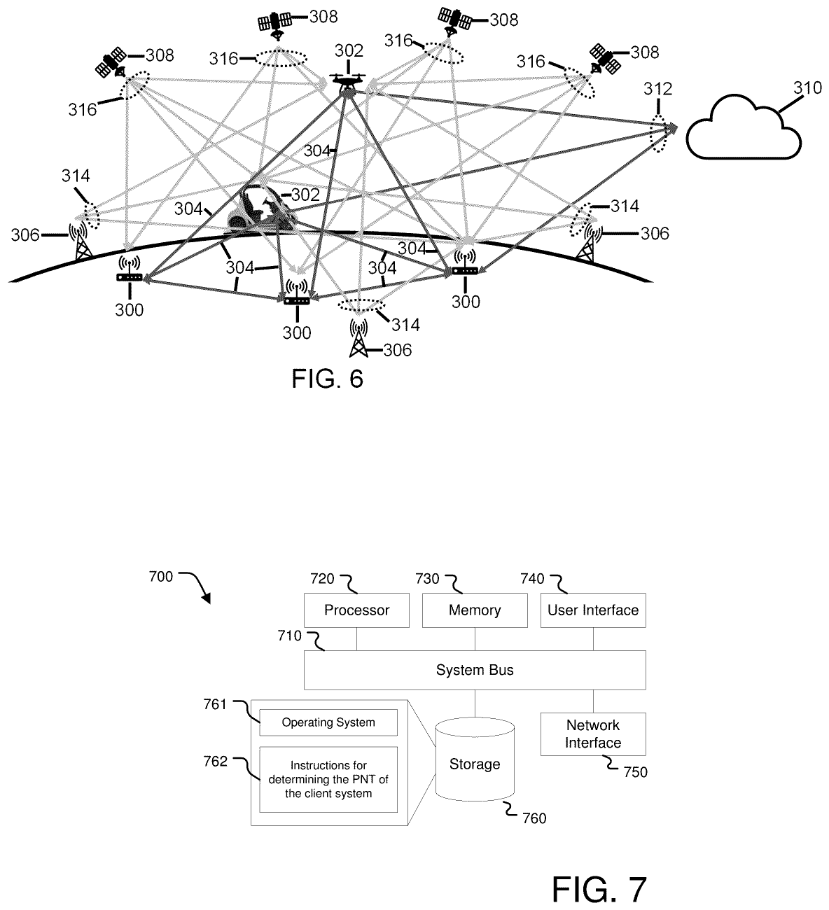

FIG. 6 illustrates a fourth embodiment of the operation of a PNT system using a combination of reference system signals, SOOP, and satellite signals for client system location and navigation when GNSS systems are not available to the client system. In FIG. 6 any combination of signals may be used to determine the location of the client system 302. For example, the signals from two satellites 308 and one SOOP system 306 may be used with one reference system 300 and the client system 302 to determine the location of the client system 302. In another variation, the signals from one satellite, one SOOP, and one reference system 300 may be used by another reference system 300 and the client system 302 to determine the location of the client system 302.

Alternatively, the satellites 308 may be used to determine the location of the client system 302. Also, the SOOP systems 306 may be used to independently determine the location of the client system 302. Then the client systems 300 may be used independently to determine the location of the client system 302 using TDOA hyperbolic lateration and/or spherical lateration. These various position location measurements may then be filtered to determine the location of the client system 302 and maintain its navigation parameters as needed.

As previously described, other location measurements may be fused with the measurements from the PNT system. Often such fused measurements provide greater accuracy than any single position measurement.

Various embodiment of a PNT system have been described that may determine the location of a client system 302 when that client system 302 is denied the use of GNSS positioning. Various combinations of client systems 302, SOOP systems 306, and satellites 308 may be used as described above to provide position and navigation information for the client system 302. Filtering such as Kalman filtering may be used to track the position and navigation state of the client system 302. This filter may also be used to predict the location of client system 302 between updates to the client system 302 location. Depending upon what systems are available at the client system 302 location, various systems may be used to determine the client system 302 location, and these measured values may be fused together. Such fused location measurements are often more accurate than positions measurements using only a single measurement. As described above, other types of position measurements (e.g., the other types of sensors including IMS, barometer, magnetometer, doppler, angle of arrival, etc.) may also be fused with the measurement from the PNT system.

One other challenge that may arise in the PNT system is correlating various received signals from the different systems. For example, multiple SOOP 314, satellite signals 316, and reference system 300 signals may be received. Each received signal needs to be identified so that it may be used for hyperbolic or spherical lateration calculations. In some cases, the signals may have explicit identifiers that indicate the source of the signal. In other cases, various characteristics of the signal may be used to identify the source of the signal so that signals may be correlated for use in location processing. The methods described in U.S. Pat. No. 11,115,297 describe methods for fingerprinting signals so that related signals may be associated with one another. These same fingerprinting techniques may be applied to the PNT system to identify signals from the same source. U.S. Pat. No. 11,115,297 is hereby incorporated, for all purposes, by reference herein in its entirety.

FIG. 7 illustrates an exemplary hardware diagram 700 for implementing PNT system. The exemplary hardware 700 may found in any of the client system 302, reference system 300, or external system 310. As shown, the device 700 includes a processor 720, memory 730, user interface 740, network interface 750, and storage 760 interconnected via one or more system buses 710. It will be understood that FIG. 7 constitutes, in some respects, an abstraction and that the actual organization of the components of the device 700 may be more complex than illustrated.

The processor 720 may be any hardware device capable of executing instructions stored in memory 730 or storage 760 or otherwise processing data. As such, the processor may include a microprocessor, microcontroller, graphics processing unit (GPU), neural network processor, field programmable gate array (FPGA), application-specific integrated circuit (ASIC), or other similar devices.

The memory 730 may include various memories such as, for example L1, L2, or L3 cache or system memory. As such, the memory 730 may include static random-access memory (SRAM), dynamic RAM (DRAM), flash memory, read only memory (ROM), or other similar memory devices.

The user interface 740 may include one or more devices for enabling communication with a user such. For example, the user interface 740 may include a display, a touch interface, a mouse, and/or a keyboard for receiving user commands. In some embodiments, the user interface 740 may include a command line interface or graphical user interface that may be presented to a remote terminal via the network interface 750.

The network interface 750 may include one or more devices for enabling communication with other hardware devices. For example, the network interface 750 may include a network interface card (NIC) configured to communicate according to the Ethernet protocol or other communications protocols, including wireless protocols. Additionally, the network interface 750 may implement a TCP/IP stack for communication according to the TCP/IP protocols. Various alternative or additional hardware or configurations for the network interface 750 will be apparent.

The storage 760 may include one or more machine-readable storage media such as read-only memory (ROM), random-access memory (RAM), magnetic disk storage media, optical storage media, flash-memory devices, or similar storage media. In various embodiments, the storage 760 may store instructions for execution by the processor 720 or data upon with the processor 720 may operate. For example, the storage 760 may store a base operating system 761 for controlling various basic operations of the hardware 700. The storage 760 may store software that implements instructions 762 to carry out the various function of the PNT system as described above.

It will be apparent that various information described as stored in the storage 760 may be additionally or alternatively stored in the memory 730. In this respect, the memory 730 may also be considered to constitute a “storage device” and the storage 760 may be considered a “memory.” Various other arrangements will be apparent. Further, the memory 730 and storage 760 may both be considered to be “non-transitory machine-readable media.” As used herein, the term “non-transitory” will be understood to exclude transitory signals but to include all forms of storage, including both volatile and non-volatile memories.

The system bus 710 allows communication between the processor 720, memory 730, user interface 740, storage 760, and network interface 750.

While the host device 700 is shown as including one of each described component, the various components may be duplicated in various embodiments. For example, the processor 720 may include multiple microprocessors that are configured to independently execute the methods described herein or are configured to perform steps or subroutines of the methods described herein such that the multiple processors cooperate to achieve the functionality described herein. Further, where the device 700 is implemented in a cloud computing system, the various hardware components may belong to separate physical systems. For example, the processor 720 may include a first processor in a first server and a second processor in a second server.

While each of the embodiments are described above in terms of their structural arrangements, it should be appreciated that the invention also covers the associated methods of using the embodiments described above.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications and combinations of the various embodiments can be affected while remaining within the spirit and scope of the invention. Accordingly, the foregoing disclosure, description, and figures are for illustrative purposes only and do not in any way limit the invention, which is defined only by the claims.

What is claimed is:

1. A method of determining the location of client system, comprising:
determining the round trip times of bidirectional communications between the client system and first, second, and third reference systems, wherein the locations of the first, second, and third reference systems are known at the time of reception from the client system and at the time of transmission to the client system;
calculating a first location of the client system using spherical lateration based upon the determined round trip times;
determining the time difference of arrival of the bidirectional communications between client system and the first, second, and third reference systems with respect to a fourth reference system wherein the location of the fourth reference system is known at the time of reception from the client system and at the time of transmission to the client system;
calculating a second location of the client system using time difference of arrival hyperbolic positioning based upon the determined time difference of arrival between the client and the first, second, third systems with respect to the fourth reference system; and
determining the position of the client system by combining the first location and the second location.

2. The method of claim 1, wherein determining the position of the client system by combining the first location and the second location includes using a Kalman filter.

3. The method of claim 1, wherein the communication from one of the first, second, or third reference system is a signal of opportunity.

4. The method of claim 3, wherein the signal of opportunity is one of a radio signal, a television signal, a mobile communication signal, a Wi-Fi signal, a satellite signal, a LORAN signal, a ham radio signal, an aid to navigation signal (VOR, ADS-B), a time reference signal, a LORAN signal, eLORAN signal, and a free space optical signal.

5. The method of claim 1, wherein determining the round trip times of the bidirectional communication is based upon position and navigation information on of the client system, first reference system, second reference system, and third reference system.

6. The method of claim 1, wherein one of the client system, first reference system, second reference system, and third reference system is moving.

7. The method of claim 1, wherein calculating a first location of the client system using spherical lateration, calculating a second location of the client system using time difference of arrival hyperbolic positioning, and determining the position of the client system by combining the first location and the second location are carried out by a networked processor.

8. The method of claim 1, wherein calculating a first location of the client system using spherical lateration, calculating a second location of the client system using time difference of arrival hyperbolic positioning, and determining the position of the client system by combining the first location and the second location are carried out by one of the first, second, third, or fourth reference systems.

9. The method of claim 1, wherein calculating a first location of the client system using spherical lateration, calculating a second location of the client system using time difference of arrival hyperbolic positioning, and determining the position of the client system by combining the first location and the second location are carried out by the client system.

10. A method of determining the location of client system, comprising:
determining the time of arrival at a reference system of first, second, and third signals of opportunity (SOOP) from first, second, and third SOOP systems wherein the locations of the reference system and the first, second, third SOOP systems are known at the time of reception of the first, second, and third SOOP;
determining the time of arrival at the client system of the first, second, and third signals of opportunity (SOOP) from the first, second, and third SOOP systems;
determining the time difference of arrival of the first, second, and third SOOP at the reference system and client system; and
calculating a location of the client system using time difference of arrival hyperbolic positioning based upon the determined time difference of arrivals of the first, second, and third SOOP at the client system and the reference system.

11. The method of claim 10, wherein the position of the client system is filtered using a Kalman filter.

12. The method of claim 10, wherein the signal of opportunity is one of a radio signal, a television signal, a mobile communication signal, a Wi-Fi signal, a satellite signal, a LORAN signal, a ham radio signal, an aid to navigation signal (VOR, ADS-B), a time reference signal, a LORAN signal, eLORAN signal, and a free space optical signal.

13. The method of claim 10, wherein one of the client system, SOOP system, and reference system is moving.

14. The method of claim 10, wherein calculating a location of the client system using time difference of arrival hyperbolic positioning is carried out by a networked processor.

15. The method of claim 10, wherein calculating the location of the client system using time difference of arrival hyperbolic positioning are carried out by the reference system.

16. The method of claim 10, wherein calculating the location of the client system using time difference of arrival hyperbolic positioning is carried out by the client system based upon time of arrival information received from a networked processor.

17. A method of determining the location of client system, comprising:
receiving, by the client system from an external system, location and navigation information regarding a plurality of satellites, wherein the external system determines the location of the plurality of satellites using time difference of arrival hyperbolic positioning based upon time difference of arrival of transmissions received from the plurality of satellites;
determining the time difference of arrival of communications received by the client system from four of the plurality of satellites; and
calculating a location of the client system using time difference of arrival hyperbolic positioning based upon the determined time difference of arrival between the client and the four satellites.

18. The method of claim 17, wherein the external system determines the position of the plurality of satellites by filtering location data of the plurality of satellites using a Kalman filter.

19. The method of claim 17, wherein the external system includes a plurality of reference systems receiving transmissions from the plurality of satellites.

20. The method of claim 19, wherein the external system includes a processor configured to determines the location of the plurality of satellites using time difference of arrival hyperbolic positioning based upon time difference of arrival communication received from the plurality of satellites.

21. The method of claim 19, wherein one of the plurality of reference systems is moving.

22. The method of claim 17, wherein the client system is moving.

23. The method of claim 17, wherein one of the client system, first reference system, second reference system, and third reference system is moving.
